(19) United States
(12) Patent Application Publication
(10) Pub. No.: US 2008/0144962 A1
(43) Pub. Date: Jun. 19, 2008

(54) Apparatus and method for enhancing color images

(75) Inventors: Deuk-Soo Jung, Seoul (KR); Yeul-Min Baek, Seoul (KR); Whoi-Yul Kim, Seoul (KR); Jin-Aeon Lee, Suwon-si (KR); Hyoung-Joon Kim, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/812,582

(22) Filed: Jun. 20, 2007

(30) Foreign Application Priority Data
Dec. 19, 2006 (KR) 10-2006-0130218

(51) Int. Cl. G06K 9/40

(52) U.S. Cl. 382/274

(57) ABSTRACT

Example embodiments are directed to an apparatus and method for enhancing an image. The method may include extracting contrast data from color image data, generating low resolution image data and band pass image data from the contrast data using a Laplacian pyramid, generating global brightness enhanced image data from the low resolution image data to enhance an overall brightness, generating local contrast ratio enhanced image data from the band pass image data to enhance a local contrast, and/or generating enhanced contrast data from the global brightness enhanced image data and the local contrast ratio enhanced data. The apparatus may include circuitry for performing similar operations.

### PRIORITY STATEMENT

This U.S. non-provisional patent application claims priority under 35 U.S.C. § 119 of Korean Patent Application No. 2006-130218, filed on Dec. 19, 2006, the entire contents of which are incorporated herein by reference.

### BACKGROUND

Methods for enhancing images with pronounced characteristics, including moving images, are becoming increasingly important. These methods may include, for example, methods based on histogram planarization, multi-scale retinex with color restoration (MSRCR), and unsharp masking using a Laplacian pyramid or wavelet transform.

Histogram planarization may be used for enhancing an image contrast ratio. However, histogram planarization may undesirably change the brightness of an image and reduce its quality. Also, histogram planarization may provide relatively little enhancement to images having a bimodal histogram. If the histogram planarization is applied to a moving image, the problem of flicker may occur on the screen, depending on histogram changes between frames. To compensate for this problem, a bin underflow and bin overflow (BUBO) method has been proposed, but this method may provide relatively little enhancement for received images having a bimodal histogram, and flicker may still occur between scenes, for example ‘fade-in/out’, where BUBO is applied to a moving image. ‘Fade-in’ allows an image to gradually appear, and ‘fade-out’ allows a screen to gradually disappear. A method for simultaneously performing ‘fade-in’ and ‘fade-out’ using two different images may be used, for example, when television programs or videos are produced.

MSRCR may reduce or prevent image quality deterioration caused by illumination by separating an image into an illumination component and a reflectance component, removing the illumination component, and recovering each color by amplifying each color channel. The MSRCR may preserve image characteristics and improve colors, but may exclude the illumination component of an image. The contrast ratio of the resulting image may improve, but undesirable brightness and color reproduction may produce unnatural results. Furthermore, a large number of calculations may be required, thereby rendering this method difficult to implement in with real-time processing.

The unsharp masking method using a Laplacian pyramid or wavelet transform may enhance an image contrast ratio by amplifying band pass images. This enhancement may be trivial, however, if the brightness of an image is relatively dark or relatively bright because a conversion of a lower resolution approximation image representing brightness by illumination may not be made. Also, an image may appear unnatural due to the undesirable enhancement of the contrast ratio in a relatively bright region of an image. This may be because local data may not be considered in determining the gain of a band pass image.

### SUMMARY

Example embodiments are directed to color image enhancement, for example, an apparatus and method for enhancing an image using a Laplacian pyramid.

A method for enhancing image quality of a color image may include extracting contrast data from color image data of the color image, generating low resolution image data and band pass image data from the contrast data using a Laplacian pyramid, generating global brightness enhanced image data from the low resolution image data to enhance overall brightness, generating local contrast ratio enhanced image data from the band pass image data to enhance local contrast, and/or generating enhanced contrast data from the global brightness enhanced image data and the local contrast ratio enhanced data. The method may also include outputting enhanced color image data obtained by combining the color image data and the enhanced contrast data.

The enhanced color image data may be proportional to a ratio of the color image data to the contrast data raised to a determining function, and also proportional to the enhanced contrast data. The determining function may be obtained by raising the contrast data to a first constant and adding a second constant, where the first constant and the second constant may be between 0 and 1. The enhanced color image data may be generated using several equations.

Generating global brightness enhanced image data from the low resolution image data may include increasing the brightness of the global brightness enhanced image data in response to a low overall brightness of the low resolution image data and/or decreasing the brightness of the global brightness enhanced image data in response to a high overall brightness of the low resolution image data. The global brightness enhanced image data may be generated using several equations.

Generating local contrast ratio enhanced image data from the band pass image data may include increasing the contrast of the local contrast ratio enhanced image data in response to a low contrast of the band pass image and/or decreasing the contrast of the local contrast ratio enhanced image data in response to a high contrast of the band pass image data. The local contrast ratio enhanced image data may be generated using several equations.

An apparatus for enhancing image quality of a color image may include contrast data extracting module a multi-resolution decomposing module, a global brightness enhancing module, a local contrast ratio enhancing module, and/or a combining module. The contrast data extracting module may be configured to extract contrast data from color image data of the color image. The multi-resolution decomposing module may be configured to generate low resolution image data and band pass image data from the contrast data using a Laplacian pyramid. The global brightness enhancing module may be configured to generate global brightness enhanced image data from the low resolution image data. The local contrast ratio enhancing module may be configured to generate local contrast ratio enhanced image data from the band pass image data. The combining module may be configured to combine the global brightness enhanced image data and the local contrast ratio enhanced image data to generate enhanced contrast data. The apparatus may also include a color reproducing module configured to generate enhanced color image data from the enhanced contrast data and the color image data.

The enhanced color image data may be proportional to a ratio of the color image data to the contrast data raised to a determining function, and also proportional to the enhanced contrast data. The determining function is obtained by raising the contrast data to a first constant and adding a second constant, where the first constant and the second constant may be between 0 and 1. The enhanced color image data may be generated using several equations.

The global brightness enhanced image data may be further configured to increase the brightness of the global brightness enhanced image data in response to a low overall brightness of the low resolution image data and/or decrease the brightness of the global brightness enhanced image data in response to a high overall brightness of the low resolution image data. The global brightness enhanced image data may be generated using several equations.

The local contrast ratio enhancing module may be further configured to increase the contrast of the local contrast ratio enhanced image data in response to a low contrast of the band pass image and/or decrease the contrast of the local contrast ratio enhanced image data in response to a high contrast of the band pass image. The local contrast ratio enhanced image data may be generated using several equations.

### BRIEF DESCRIPTION OF THE FIGURES

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a block diagram of an example apparatus for enhancing an image according to an example embodiment.

FIG. 2 is a view illustrating a Laplacian pyramid expressing an image in multiple resolutions.

FIG. 3 is a view illustrating an example image decomposed as a Laplacian pyramid using the multi-resolution decomposing module 20 illustrated in FIG. 1.

FIG. 4 is a graph illustrating a mapping function that may be used by the global brightness enhancing module 30 illustrated in FIG. 1.

FIG. 5 is a graph illustrating a gain function that may be used by the local contrast ratio enhancing module 40 illustrated in FIG. 1.

FIG. 6 is a graph illustrating a determining function according to Equation 7.

FIG. 7 is a view comparing image enhancement results of a relatively dark example image according to example embodiments and the conventional art.

FIG. 8 is a view comparing image enhancement results of a relatively bright example image according to example embodiments and the conventional art.

FIG. 9 is a view comparing image enhancement results of an image having both relatively bright and relatively dark regions according to example embodiments and the conventional art.

FIG. 10 is a flowchart illustrating a method for enhancing an image according to example embodiments.

### DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

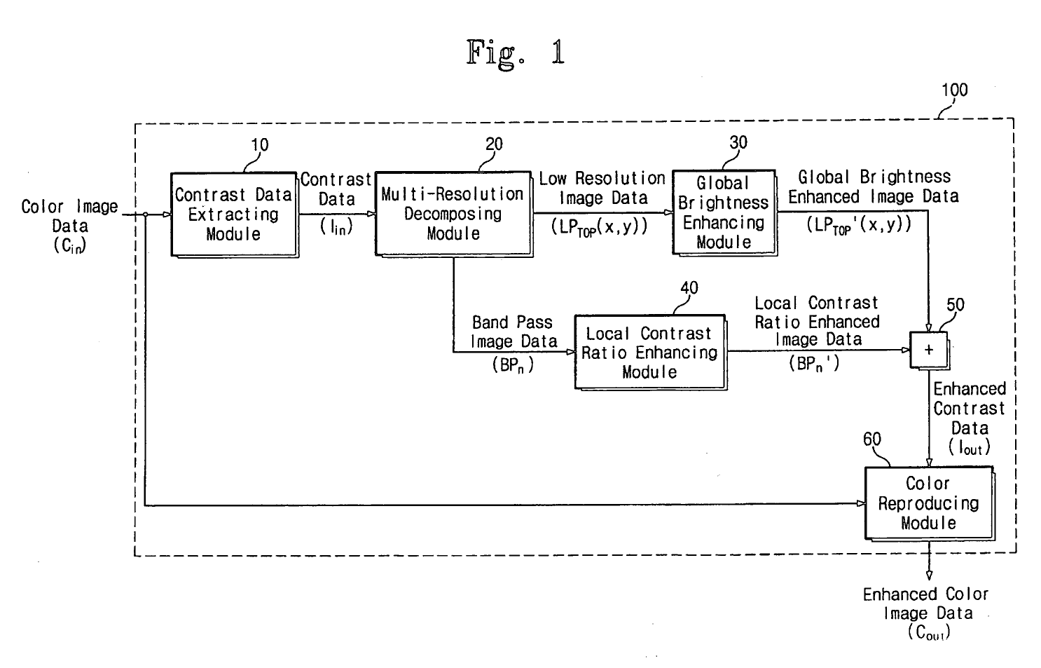

FIG. 1 is a block diagram of an apparatus for enhancing an image according to an example embodiment. Referring to FIG. 1, the apparatus may include a contrast data extracting module 10, a multi-resolution decomposing module 20, a global brightness enhancing module 30, a local contrast ratio enhancing module 40, a combining module 50, and/or a color reproducing module 60.

The contrast data extracting module 10 may extract data corresponding to contrast data from received color image data. The multi-resolution decomposing module 20 may generate low resolution image data and band pass image data using a Laplacian pyramid. The global brightness enhancing module 30 may enhance the overall brightness of the contrast data. The local contrast ratio enhancing module 40 may enhance a local contrast ratio of the band pass image data. The combining module 50 may combine the output of the global brightness enhancing module 30 and the output of the local contrast ratio enhancing module 40 to generate enhanced contrast data. The color reproducing module 60 may combine the enhanced contrast data and the color image data to generate enhanced color image data.

When color image data Cᵢₙ is received, the contrast data extracting module 10 may extract contrast data Iᵢₙ from the color image data Cᵢₙ. The multi-resolution decomposing module 20 may receive contrast data Iᵢₙ using a Laplacian pyramid to generate low resolution image data LP_{TOP}(x, y) and band pass image data BPₙ. The global brightness enhancing module 30 may receive the low resolution image data LP_{TOP}(x, y) and control the brightness to generate global brightness enhanced data LP_{TOP}′(x, y). The local contrast ratio enhancing module 40 may receive band pass image data BPₙ and control the contrast ratio of a partially darkened portion to generate local contrast ratio enhancing data BP′. The combining module 50 may combine the global brightness enhanced data LP_{TOP}′(x, y) with the local contrast ratio enhancing data BPₙ′ to generate enhanced contrast data Iₒᵤₜ. The color reproducing module 60 may receive the enhanced contrast data Iₒᵤₜ and the color image data Cᵢₙ to output enhanced color image data Cₒᵤₜ.

When an object has a small size or a low contrast ratio, it may be desirable to observe the object at a higher resolution. However, when an object has a large size or a high contrast ratio, it may be desirable to observe the object at a lower resolution. Therefore, if relatively small or relatively low contrast objects exist simultaneously in an image with relatively large or relatively high contrast objects, it may be desirable to observe the image in multiple resolutions.

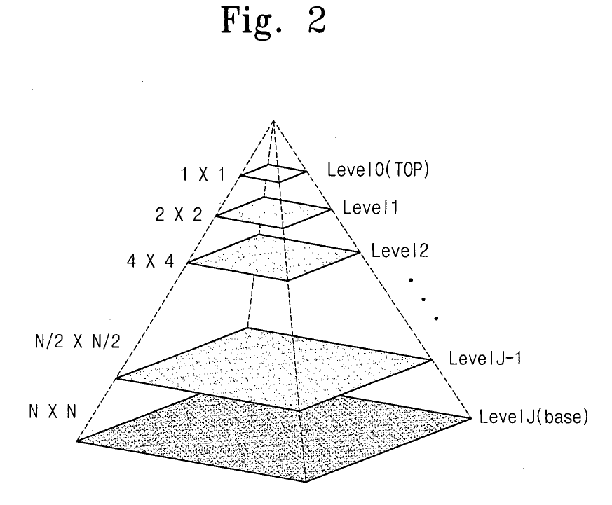

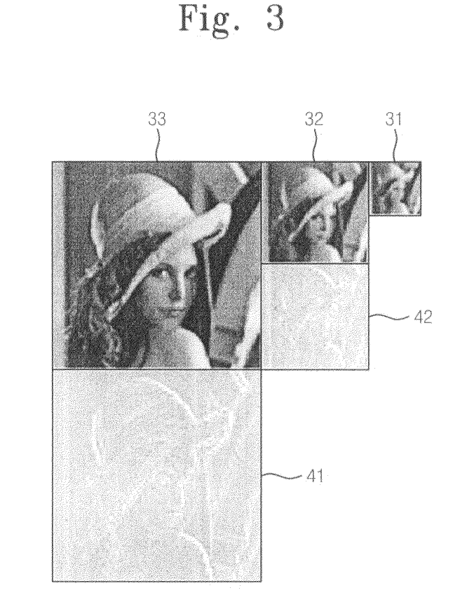

FIG. 2 is a view illustrating a Laplacian pyramid for expressing an image in multiple resolutions, and FIG. 3 is a view illustrating an example image decomposed as a Laplacian pyramid using the multi-resolution decomposing module 20 illustrated in FIG. 1.

Referring to FIG. 2, the base of the pyramid may include a relatively high resolution expression of an image to be processed, and the top may include a relatively low resolution approximation. The size and resolution of an image may be reduced in moving from the base toward the upper portion of the pyramid. A base level J of the pyramid may have a size of 2^{j}×2^{j} or N×N, where J=log₂N. An intermediate level j may have a size of 2^{j}×2^{j}, where 0≦j≦J.

A lower resolution level of the pyramid may be used for analyzing a large structure, for example, the background of an image, etc . . . , and a higher resolution level may be used for analyzing characteristics of individual objects, or other small structures. In pattern recognition, for example, it may be useful to move from a rough analysis to a more detailed analysis using different levels of resolution.

Methods for enhancing the image according to example embodiments may include globally enhancing the brightness of an image caused by illumination and locally enhancing the contrast ratio of the image. For example, image data may be separated into a brightness component caused by illumination and a contrast ratio component.

Since the brightness component of the image may have a uniform spatial distribution, it may include relatively pronounced low frequency components, and since the contrast ratio component may relate to boundaries and more detailed data of the image, it may include relatively pronounced high frequency components. A variety of methods, for example, homomorphic filtering, MSRCR using fast Fourier transform (FFT), a Laplacian pyramid, wavelet transform, etc . . . , may be used in order to decompose an image into high frequency components and low frequency components. Thus, while a Laplacian pyramid is disclosed in relation to the example embodiments contained herein, other frequency decomposition methods may be used without deviating from the intended scope.

According to example embodiments, a brightness component and a contrast ratio component of an image may be separated from a received image using a Laplacian pyramid. Equations 1 and 2 below may be used in constructing a Laplacian pyramid.

LPₙ₊₁=S↓(F*LP) (Equation 1)

BPₙ=LPₙ−S↑LPₙ₊₁ (Equation 2)

Referring to Equations 1 and 2, LPₙ₊₁ may correspond to a low resolution image (a Gaussian pyramid), for forming a Laplacian pyramid and BPₙ may correspond to a band pass image (a Laplacian pyramid). Here, ‘n’ may denote the n-th layer of the Laplacian pyramid, S↓ may denote sub-sampling, S↑ may denote up-sampling, and F may denote a Gaussian mask. FIG. 3 illustrates low resolution images 31-33 and band pass images 41-42.

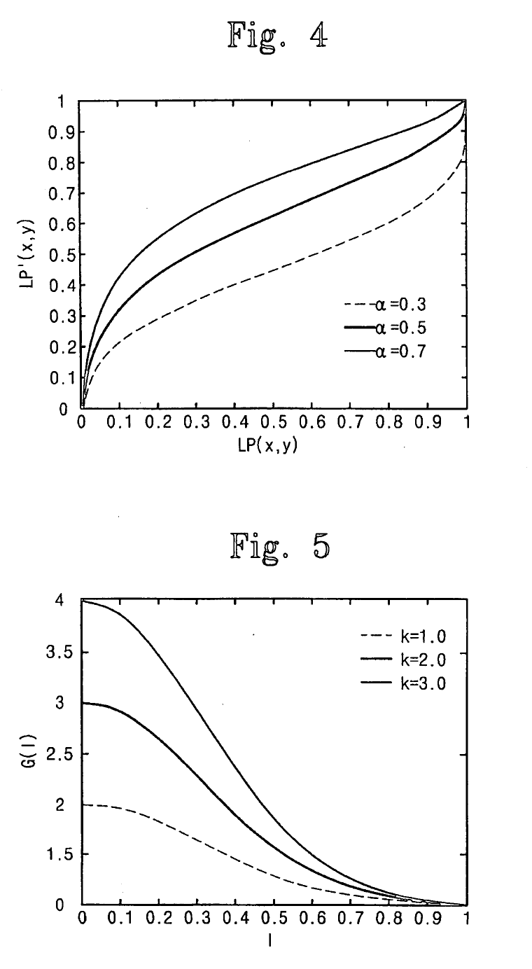

FIG. 4 is a graph illustrating a mapping function used by the global brightness enhancing module 30 illustrated in FIG. 1. A mapping function corresponding to the shape illustrated in FIG. 4 is given by Equation 3.

LP_{TOP}′(x,y)=−{−c ln(LP_{TOP}(x,y))}^{a}+1 (Equation 3)

Referring to FIGS. 1 through 4, Equation 3 may be used to increase the brightness of a region where illumination of a received image LP_{TOP}(x, y) is relatively dark, and to decrease the brightness of a region where illumination is relatively bright. a and c are constants between 0 and 1. For example, when the overall brightness of the lower resolution image is relatively low, Equation 3 may be applied to the global brightness enhanced image data to increase the brightness, and when the overall brightness of a lower resolution image is relatively high, Equation 3 may be applied to the global brightness enhanced image data to decrease the brightness.

A lower resolution approximation image LP_{TOP}(x, y) located at the uppermost layer of the Laplacian pyramid may correspond to the overall brightness component of an image caused by illumination. Therefore, the global brightness enhanced image data LP_{TOP}′(x, y), where the overall brightness of an image caused by illumination has been enhanced, may be generated by applying the mapping function of Equation 3 to this lower resolution approximation image.

FIG. 5 is a graph illustrating a gain function that may be used by the local contrast ratio enhancing module 40 illustrated in FIG. 1.

G(I)=k exp(−I²/c)+1 (Equation 4)

BPₙ′=G(LPₙ₊₁(x,y))×BPₙ (Equation 5)

Band pass images BPₙ of a Laplacian pyramid obtained using Equation 2 may correspond to the contrast ratio components of received images. The contrast ratio of the received images may be enhanced by increasing the range of their respective band pass images as in Equation 5. In Equation 4, k may be a constant greater than 1, and c may be a constant between 0 and 1.

G(I) in Equation 4 may be used as a gain function. For example, as illustrated in FIG. 5, G(I) may reflect a certain characteristic of the human visual system that may be sensitive to a contrast ratio under relatively dark illumination, but not as sensitive under relatively bright illumination.

When the contrast of the band pass image data BPₙ is relatively low, the local contrast ratio enhanced image data BPₙ′ may correspond to an increase in the local contrast ratio, and when the contrast of the band pass image data BPₙ is relatively high, the local contrast ratio enhanced image data BPₙ′ may correspond to a decrease in the local contrast ratio.

In addition to enhancing the brightness of an image using a Laplacian pyramid based on brightness values of a received image, the colors may be reproduced using the brightness values of both the enhanced image and the received image. Equations 6 and 7 may be used to reproduce the colors of an image.

Cₒᵤₜ=(Cᵢₙ/Iᵢₙ)^{S}×Iₒᵤₜ (Equation 6)

S=Iᵢₙ^{γ}+β (Equation 7)

Equation 6 by itself may correspond to a conventional method used for reproducing colors. C may be a color component value of each red R, green G, and blue B color, Iᵢₙ may correspond to contrast data of a received image, Iₒᵤₜ may correspond to contrast data enhanced using a Laplacian pyramid, and ‘S’ may be a constant. Because Equation 6 may be used to increase the saturation of a relatively low saturation region of a received image, certain unnatural colors may be reproduced in darker regions of the image.

However, according to example embodiments, a saturation increase in a relatively low saturation region may be suppressed in order to reproduce natural colors by using the determining function ‘S’ of Equation 7, which may use the contrast data of the received image, in place of the constant S of Equation 6. γ and β may be constants between 0 and 1.

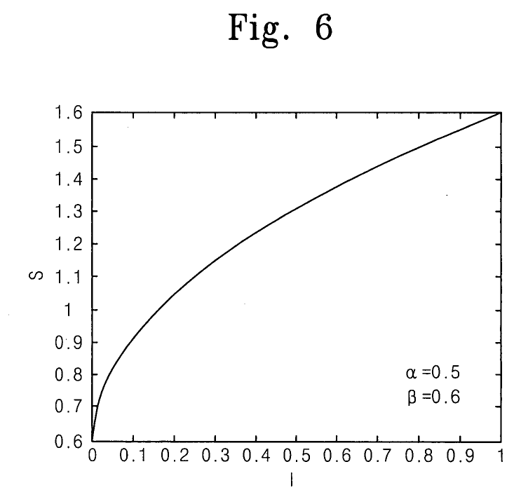

FIG. 6 is a graph illustrating the determining function S according to Equation 7.

Referring to FIG. 6, the color reproducing module 60 of FIG. 1 may reproduce natural colors Cₒᵤₜ according to Equations 6 and 7 using contrast data Cᵢₙ (from a received image) and enhanced contrast data Iₒᵤₜ (from the global brightness enhancing module 30 and the local contrast ratio enhancing module 40).

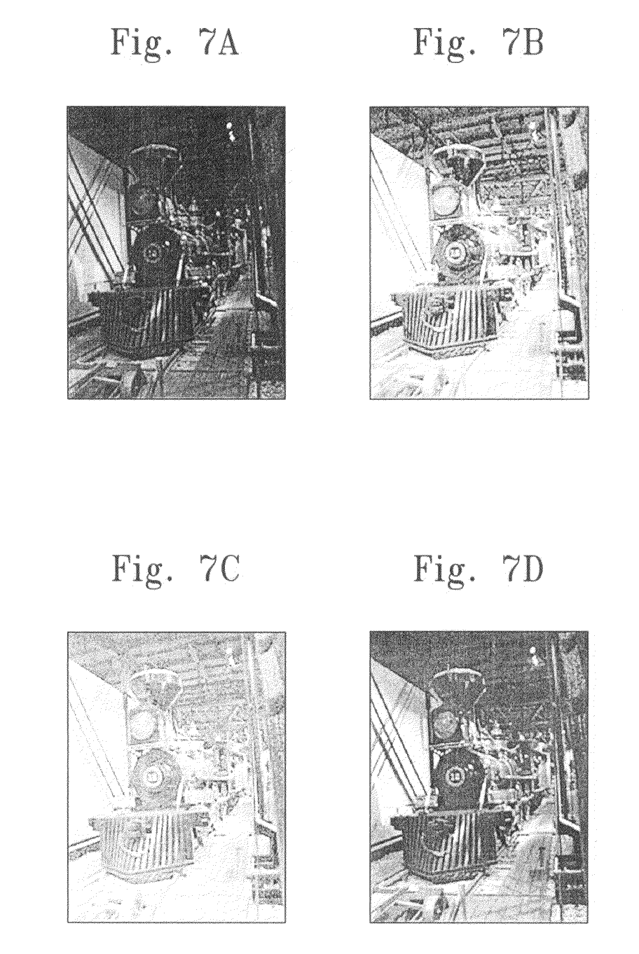

FIGS. 7, 8 and 9 each illustrate differences between conventional image enhancement and image enhancement according to example embodiments, as applied to different types of received images. FIGS. 7, 8, and 9 each show four separate images, labeled A-D. FIGS. 7A, 8A, and 9A show example received images; FIGS. 7B, 8B, and 9B show images obtained by processing a corresponding received image using conventional histogram planarization; FIGS. 7C, 8C, and 9C show images obtained by processing a corresponding received image using conventional MSRCR; and FIGS. 7D, 8D, and 9D show images obtained by processing a corresponding received image according to example embodiments.

FIG. 7A shows a relatively dark example received image. By applying conventional histogram planarization or MSRCR image enhancement to the relatively dark example received image, the contrast may be enhanced, but the brightness may appear unnatural, as shown in FIGS. 7B and 7C, respectively. In comparison, by applying image enhancement according to example embodiments, the contrast may be enhanced while maintaining a more natural brightness, as shown in FIG. 7D.

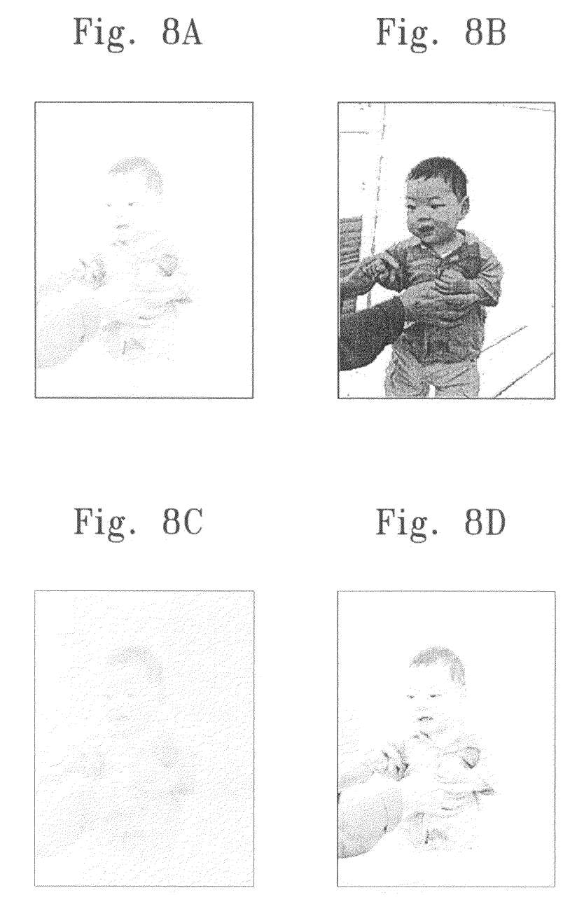

FIG. 8A shows a relatively bright example image. By applying conventional histogram planarization image enhancement to the relatively bright example image, an object within the image may become undesirably dark due to an excessive contrast ratio increase, as shown in FIG. 8B. By applying conventional MSRCR image enhancement to the relatively bright example image, the image quality may be undesirably reduced due to the similarity of pixel brightness values in the original image, the size of the object within the image, and/or the reflection from the background, even when the brightness is reduced, as shown in FIG. 8C. In comparison, by applying image enhancement according to example embodiments, the contrast ratio may be enhanced while maintaining brightness, as shown in FIG. 8D.

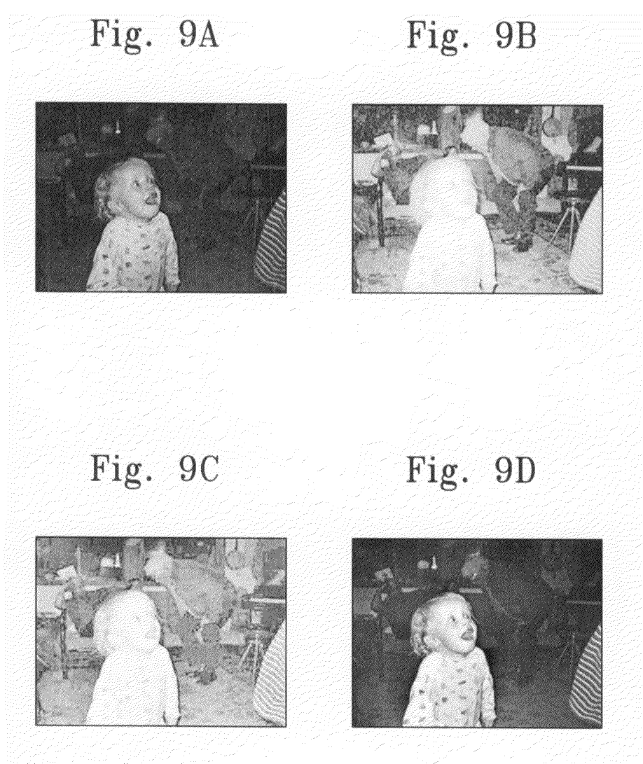

FIG. 9A shows an example received image with both relatively bright and relatively dark regions. By applying conventional histogram planarization or MSRCR image enhancement to the example received image, the brightness and contrast ratio may be enhanced in the relatively dark region, but the contrast ratio of the relatively bright region may be undesirably reduced, as shown in FIGS. 9B and 9C, respectively. In comparison, by applying image enhancement according to example embodiments, the brightness and contrast ratio of the relatively dark region may be enhanced while maintaining the contrast ratio of the relatively bright region, as shown in FIG. 9D.

Furthermore, image enhancement according to example embodiments may improve the reproduction of natural colors and, if applied to a moving image, reduce or eliminate flicker, even when switching scenes, including during ‘fade-in’ and/or ‘fade-out’. Example embodiments may also process QVGA class resolution in real-time. For example, a moving image having a resolution of 320×240 may be processed in real-time (31 ms) using a central processing unit speed of 2.0 GHz.

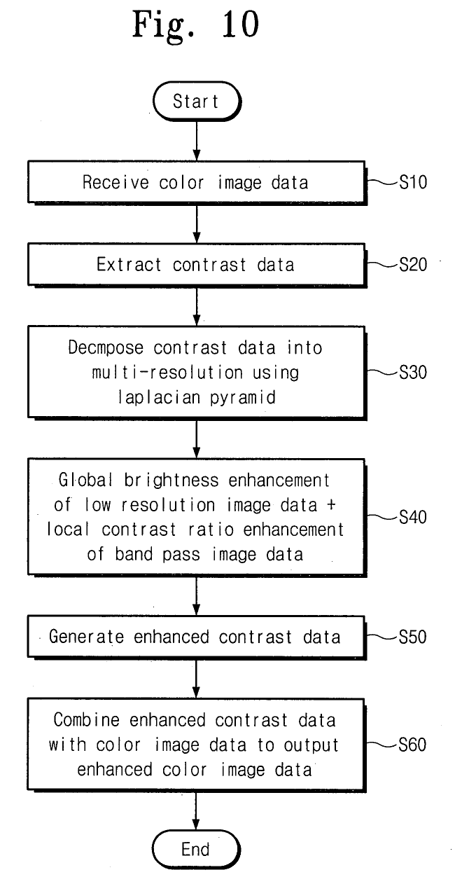

FIG. 10 is a flowchart illustrating a method of image enhancement according to example embodiments.

Referring to FIG. 10, color image data may be received for enhancing an image in operation S10. Contrast data may be extracted from the color image data in operation S20. The contrast data may be used to generate low resolution image data, and to generate band pass image data in operation S30. The low resolution image data may be used to control the brightness of the image in order to generate global brightness enhanced image data, and the band pass image data may be used to control the contrast ratio of a relatively dark region in order to generate local contrast ratio enhanced image data in operation S40. The global brightness enhanced image data and the local contrast ratio enhanced image data may be combined to generate enhanced contrast data in operation S50. The enhanced contrast data and the color image data may be used to generate enhanced color image data in operation S60.

For example, color image data Cᵢₙ may be received for enhancing an image and contrast data may be extracted from the color image data. The contrast data may be used to generate low resolution image data LP_{TOP}(x, y) using Equation 1, and to generate band pass image data BPₙ using Equation 2. The low resolution image data LP_{TOP}(x, y) may be used to control the brightness of the image according to Equation 3 in order to generate global brightness enhanced image data LP_{TOP}′(x, y), and the band pass image data BPₙ may be used to control the contrast ratio of a relatively dark region according to Equation 5 in order to generate local contrast ratio enhanced image data BPₙ′. The global brightness enhanced image data LP_{TOP}′(x, y) and the local contrast ratio enhanced image data BPₙ′ may be combined to generate enhanced contrast data Iₒᵤₜ. The enhanced contrast data Iₒᵤₜ and the color image data Cᵢₙ may be used to generate enhanced color image data Cₒᵤₜ using Equations 6 and 7.

Thus, a received image may be decomposed into multiple resolutions using a Laplacian pyramid. Brightness enhancement by illumination of an overall image may be performed using a low resolution approximation image and local contrast ratio enhancement may be performed using a band pass image. Natural colors may be reproduced by outputting an enhanced image through a saturation increase suitable for the brightness of a received image.

Example embodiments having thus been described, it will be obvious that the same may be varied in many ways. For example, the methods according to example embodiments may be implemented in hardware and/or software. The hardware/software implementations may include a combination of processor(s) and article(s) of manufacture. The article(s) of manufacture may further include storage media and executable computer program(s), for example, a computer program product stored on a computer readable medium.

The executable computer program(s) may include the instructions to perform the described operations or functions. The computer executable program(s) may also be provided as part of externally supplied propagated signal(s). Such variations are not to be regarded as a departure from the intended spirit and scope of example embodiments, and all such modifications as would be obvious to one skilled in the art are intended to be included within the scope of the following claims.

What is claimed is:

1. A method for enhancing image quality of a color image, the method comprising:
extracting contrast data from color image data of the color image;
generating low resolution image data and band pass image data from the contrast data using a Laplacian pyramid;
generating global brightness enhanced image data from the low resolution image data to enhance overall brightness;
generating local contrast ratio enhanced image data from the band pass image data to enhance local contrast; and
generating enhanced contrast data from the global brightness enhanced image data and the local contrast ratio enhanced data.

2. The method of claim 1, further comprising:
outputting enhanced color image data obtained by combining the color image data and the enhanced contrast data.

3. The method of claim 2, wherein the enhanced color image data is proportional to a ratio of the color image data to the contrast data raised to a determining function and proportional to the enhanced contrast data.

4. The method of claim 3, wherein the determining function is obtained by raising the contrast data to a first constant and adding a second constant.

5. The method of claim 4, wherein the first constant and the second constant are between 0 and 1.

6. The method of claim 2, wherein the enhanced color image data is generated using the following Equations:
Cₒᵤₜ=(Cᵢₙ/Iᵢₙ)^{S}×Iₒᵤₜ
S=Iᵢₙ^{γ}+β,
where Cₒᵤₜ is the enhanced color image data, Cᵢₙ is the color image data, Iᵢₙ is the contrast data, S is a determining function, and γ and β are constants between 0 and 1.

7. The method of claim 1, wherein generating global brightness enhanced image data from the low resolution image data comprises:
increasing the brightness of the global brightness enhanced image data in response to a low overall brightness of the low resolution image data; and
decreasing the brightness of the global brightness enhanced image data in response to a high overall brightness of the low resolution image data.

8. The method of claim 7, wherein the global brightness enhanced image data is generated using the following Equation:
LP_{TOP}′(x,y)=−{−c ln(LP_{TOP}(x,y))}^{a}+1,
where LP_{TOP}′(x, y) is the global brightness enhanced image data, LP_{TOP}(x, y) is the low resolution image data, x and y are coordinates of the Laplacian pyramid, and a and c are constants between 0 and 1.

9. The method of claim 1, wherein generating local contrast ratio enhanced image data from the band pass image data comprises:
increasing the contrast of the local contrast ratio enhanced image data in response to a low contrast of the band pass image; and
decreasing the contrast of the local contrast ratio enhanced image data in response to a high contrast of the band pass image data.

10. The method of claim 9, wherein the local contrast ratio enhanced image data is generated using the following Equations:
BPₙ′=G(LPₙ₊₁(x,y))×BPₙ
G(I)=k exp(−I²/c)+1,
where BPₙ′ is the local contrast ratio enhanced image data, I is contrast data, BPₙ is the band pass image data, k is a constant greater than 1, LPₙ₊₁(x,y) is low resolution contrast data, and c is a constant between 0 and 1.

11. An apparatus for enhancing image quality of a color image, the apparatus comprising:
a contrast data extracting module configured to extract contrast data from color image data of the color image;
a multi-resolution decomposing module configured to generate low resolution image data and band pass image data from the contrast data using a Laplacian pyramid;
a global brightness enhancing module configured to generate global brightness enhanced image data from the low resolution image data;
a local contrast ratio enhancing module configured to generate local contrast ratio enhanced image data from the band pass image data; and
a combining module configured to combine the global brightness enhanced image data and the local contrast ratio enhanced image data to generate enhanced contrast data.

12. The apparatus of claim 11, further comprising:
a color reproducing module configured to generate enhanced color image data from the enhanced contrast data and the color image data.

13. The apparatus of claim 12, wherein the enhanced color image data is proportional to a ratio of the color image data to the contrast data raised to a determining function and proportional to the enhanced contrast data.

14. The apparatus of claim 13, wherein the determining function is obtained by raising the contrast data to a first constant and adding a second constant.

15. The apparatus of claim 14, wherein the first constant and the second constant are between 0 and 1.

16. The apparatus of claim 12, wherein the color reproducing module is configured to generate the enhanced color image data using the following Equations:
Cₒᵤₜ=(Cᵢₙ/Iᵢₙ)^{S}×Iₒᵤₜ
S=Iᵢₙ^{γ}+β,
where Cₒᵤₜ is the enhanced color image data, Cᵢₙ is the color image data, Iᵢₙ is the contrast data, S is a determining function, and γ and β are constants between 0 and 1.

17. The apparatus of claim 11, wherein the global brightness enhancing module is further configured to increase the brightness of the global brightness enhanced image data in response to a low overall brightness of the low resolution image data and decrease the brightness of the global brightness enhanced image data in response to a high overall brightness of the low resolution image data.

18. The apparatus of claim 17, wherein the global brightness enhancing module is configured to generate the global brightness enhanced image data using the following Equation:
LP_{TOP}′(x,y)={−c ln(LP_{TOP}(x,y))}^{a}+1,
where LP_{TOP}′(x, y) is the global brightness enhanced image data, LP_{TOP}(x, y) is the low resolution image data, x and y are coordinates of the Laplacian pyramid, and a and c are constants between 0 and 1.

19. The apparatus of claim 11, wherein the local contrast ratio enhancing module is further configured to increase the contrast of the local contrast ratio enhanced image data in response to a low contrast of the band pass image and decrease the contrast of the local contrast ratio enhanced image data in response to a high contrast of the band pass image.

20. The apparatus of claim 19, wherein the local contrast ratio enhancing module is configured to generate the local contrast ratio enhanced image data using the following Equations:
BPₙ′=G(LPₙ₊₁(x,y))×BPₙ
G(I)=k exp(−I²/c)+1,
where BPₙ′ is the local contrast ratio enhanced image data, I is contrast data, BPₙ is the band pass image data, k is a constant greater than 1, LPₙ₊₁(x,y) is low resolution contrast data, and c is a constant between 0 and 1.
